(19) United States
(12) Patent Application Publication
(10) Pub. No.: US 2026/0001796 A1
(43) Pub. Date: Jan. 1, 2026

(54) BIOLOGICALLY ACTIVE PERVIOUS STRUCTURE (BAPS): A SUSTAINABLE TECHNOLOGY FOR RUNOFF WATER QUALITY IMPROVEMENT

(71) Applicant: TEXAS STATE UNIVERSITY, San Marcos, TX (US)

(72) Inventors: Sangchul S. Hwang, San Marcos, TX (US); Ranjit Gurav, Uttarakhand (IN)

(73) Assignee: TEXAS STATE UNIVERSITY, San Marcos, TX (US)

(21) Appl. No.: 19/254,219

(22) Filed: Jun. 30, 2025

Related U.S. Application Data
(60) Provisional application No. 63/665,344, filed on Jun. 28, 2024.

(51) Int. Cl. C02F 3/30; C02F 3/10; C02F 103/00; C04B 28/04; C04B 40/00; C04B 103/00

(52) U.S. Cl. CPC C02F 3/30; C02F 3/106; C04B 28/04; C04B 40/0028; C02F 2103/001; C04B 2103/0001

(57) ABSTRACT

The present disclosure pertains to a composition that includes a porous structure associated with one or more biochars and one or more micro-organisms. The present disclosure also pertains to methods of capturing contaminants from an environment by associating the environment with a composition of the present disclosure. The present disclosure also pertains to methods of making the compositions of the present disclosure by associating one or more biochars and one or more micro-organisms with a porous structure.

### CROSS-REFERENCE TO RELATED APPLICATIONS

This application claims priority to U.S. Provisional Patent Application No. 63/665,344, filed on Jun. 28, 2024. The entirety of the aforementioned application is incorporated herein by reference.

### BACKGROUND

A need exists for more effective methods and systems for facilitating environmental remediation. Numerous embodiments of the present disclosure aim to address the aforementioned need.

### SUMMARY

In some embodiments, the present disclosure pertains to a composition. In some embodiments, the composition includes a porous structure that is associated with one or more biochars and one or more micro-organisms.

Additional embodiments of the present disclosure pertain to methods of capturing one or more contaminants from an environment by associating the environment with a composition of the present disclosure. In some embodiments, the composition captures one or more contaminants from the environment. In some embodiments, the captured contaminants include, without limitation, inorganic contaminants, organic contaminants, microorganisms, fertilizers, pesticides, dyes, salts, toxins, or combinations thereof. In some embodiments, the biochars of the composition capture contaminants from the environment while the micro-organisms of the composition degrade the captured contaminants.

Additional embodiments of the present disclosure pertain to methods of making the compositions of the present disclosure. In some embodiments, the methods of the present disclosure include associating one or more biochars and one or more micro-organisms with a porous structure.

### FIGURES

FIG. 1 provides a scheme for production and application of a biologically active pervious structure (BAPS).

FIGS. 2A and 2B provide images of the produced BAPS, including aggregate grade 5 (¼″) (FIG. 2A) and Aggregate grade 3 (⅝″) (FIG. 2B).

FIG. 3 shows an image of bacteria colonized inside the BAPS.

FIG. 4 provides a depiction of the use of the BAPS in water remediation.

FIG. 5 illustrates the testing of conventional limestone aggregate (CLA)-based pervious concrete blocks.

FIGS. 6A-6H provide data of water quality performance of BAPS for chemical oxygen demand (COD).

FIGS. 7A-7H provide water quality performance of BAPS for nitrate.

FIGS. 8A-8H provide water quality performance of BAPS for phosphate.

FIGS. 9A-9H provide water quality performance of BAPS for pH.

FIGS. 10A-10B show cylindrical lightweight expanded clay aggregate (LECA)-based pervious concrete (FIG. 10A) and square conventional limestone aggregate (CLA)-based pervious concrete in the mold (FIG. 10B).

FIG. 11 shows the trend of absorbance at 291 nm for the quantification of 2,4-D concentration.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Global rise in temperature is shifting the snow and rainfall pattern. Additionally, more extreme climate events, such as heavy rainstorms and record-high temperatures, are becoming more common. United States Environmental Protection Agency (EPA) indicators provide evidence of these changes and their impacts on people and the environment. Similarly, anthropogenic activities and deforestation for the construction of infrastructure are creating major alterations in the structure and function of the environment.

Additionally, polluted runoff is one of the greatest risks to clean water resources in the United States. The surface runoff gets loaded with fertilizer, polycyclic aromatic hydrocarbons, volatile organic compounds, heavy metals, pesticides, pathogens, and other similar pollutants as it makes its way through storm drains and ditches.

In fact, an estimated 10 trillion gallons of untreated stormwater runoff, containing raw sewage, trash, chemicals, fertilizers, hydrocarbons, road salts, toxins, and other harmful substances enter U.S. waterways from city sewer systems every year, polluting the environment, waterways, and aquifers, as well as causing erosion. In many urban and suburban areas with high densities of non-pervious surfaces (e.g., roads, sidewalks, parking lots, etc.), this runoff can also cause significant flooding.

The detrimental effects of groundwater runoff (e.g., erosion, aquifer, and waterway contamination) are typically addressed through a range of technologies. Such technologies include structure-specific devices (e.g., downspouts/gutters, cisterns), community-based systems (e.g., settling ponds/basins, and/or bioretention areas), and coastal techniques such as breakwaters. The majority of these techniques primarily focus on groundwater/runoff flow minimization, with only a secondary focus on water contaminants.

The use of biochar as a carbon sink is being used across a variety of industries, including use as a soil amendment, in animal feedstocks, and as a water filtration treatment to reduce nutrient runoff. Biochar has also been incorporated into the manufacture of concretes as a technique to both increase the strength of the material and to reduce greenhouse gases (e.g., (GHG)/CO₂ emissions) resulting from its manufacture as a partial substitute for Portland cement.

However, most of the pervious structures reported earlier are only considered for physical runoff water infiltration. Moreover, such structures have limited bioremediation capabilities.

As such, a need exists for more effective methods and systems for facilitating environmental remediation. Numerous embodiments of the present disclosure aim to address the aforementioned limitations.

### Compositions

In some embodiments, the present disclosure pertains to a composition. In some embodiments, the composition includes a porous structure that is associated with one or more biochars and one or more micro-organisms. As set forth in more detail herein, the compositions of the present disclosure can have numerous embodiments.

### Porous Structures

The compositions of the present disclosure can include numerous types of porous structures. For instance, in some embodiments, the porous structure is a pervious structure. In some embodiments, the porous structure includes concrete. In some embodiments, the porous structure includes limestone aggregate (CLA)-based pervious concrete. In some embodiments, the porous structure is derived from cement, such as Portland type-I cement.

### Biochar

The compositions of the present disclosure can include various types of biochar. For instance, in some embodiments, the biochar includes a waste biomass-derived biochar. In some embodiments, the biochars are derived from one or more precursors. In some embodiments, the one or more precursors include, without limitation, invasive weed giant reed, water hyacinth, water lettuce, wheat bran, pine, oak, corn stalks, vine waste, pine tree pruning waste, or combinations thereof. In some embodiments, the precursors include a combination of giant reed, water hyacinth, and water lettuce. In some embodiments, the precursors include a combination of giant reed, water lettuce, wheat bran, pine, and oak.

### Micro-Organisms

The compositions of the present disclosure can include various types of micro-organisms. For instance, in some embodiments, the micro-organisms include one or more bacteria. In some embodiments, the bacteria are colonized within a porous structure. In some embodiments, the bacteria include, without limitation, Rhodococcus sp., Pseudomonas sp., Sphingobium sp., Bacillus sp., Aeromonas sp., or combinations thereof.

Association of Biochars and Micro-Organisms with Porous Structures

Biochars and micro-organisms may be associated with porous structures in various manners. For instance, in some embodiments, the biochars and micro-organisms are dispersed within the porous structure. In some embodiments, the biochars and micro-organisms are impregnated with the porous structure. In some embodiments, the biochars and micro-organisms are infiltrated into the porous structure.

Methods of Capturing Contaminants from an Environment

Additional embodiments of the present disclosure pertain to methods of capturing one or more contaminants from an environment by associating the environment with a composition of the present disclosure. In some embodiment, the composition captures one or more contaminants from the environment. As set forth in more detail herein, the methods of the present disclosure can have numerous embodiments.

### Environments

The methods and compositions of the present disclosure may be utilized to treat various environments. For instance, in some embodiments, the environment includes, without limitation, a gaseous environment, a liquid environment, or combinations thereof. In some embodiments, the environment includes an airstream.

In some embodiments, the environment includes a water source. In some embodiments, the water source includes runoff water. In some embodiments, the water source includes polluted runoff water.

Capture of Contaminants from an Environment

The methods and compositions of the present disclosure may be utilized to capture various contaminants from an environment. For instance, in some embodiments, the contaminants include, without limitation, inorganic contaminants (e.g., nitrates and/or phosphates), organic contaminants, microorganisms (e.g., E. coli), fertilizers, pesticides (e.g., herbicides, such as 2,4-dichlorophenoxyacetic acid), dyes, salts, toxins, or combinations thereof.

In some embodiments, the contaminants include one or more inorganic contaminants. In some embodiments, the inorganic contaminants include, without limitation, heavy metals, cadmium, lead, nitrates, phosphates, ammonia, or combinations thereof.

In some embodiments, the contaminants include one or organic contaminants. In some embodiments, the organic contaminants include, without limitation, organic pollutants, volatile organic compounds, hydrocarbons, polycyclic aromatic hydrocarbons, 2,4-dichlorophenoxyacetic acid, or combinations thereof.

In some embodiments, the contaminants include one or more microorganisms. In some embodiments, the microorganisms include, without limitation, pathogens, bacteria, fungi, viruses, or combinations thereof. In some embodiments, the contaminants include bacteria.

Without being bound by theory, the methods and compositions of the present disclosure can capture contaminants through various mechanisms. For instance, in some embodiments, the biochars of the composition capture one or more contaminants from the environment while the micro-organisms of the composition degrade the captured contaminants. In some embodiments, the capture occurs through non-covalent interactions. In some embodiments, the capture occurs through adsorption.

Association of Environment with Compositions

Various methods may be utilized to associate an environment with a composition of the present disclosure. For instance, in some embodiments, the association occurs by flowing the environment through the composition. In some embodiments, the flowing occurs through the use of a flow-through system that includes the compositions of the present disclosure. In some embodiments, the environment may be infiltrated through the compositions of the present disclosure in the flow-through system. In some embodiments, the association occurs by incubating the environment with the composition. In some embodiments, the incubation occurs by submerging the compositions of the present disclosure in the environment (e.g., contaminated water).

### Methods of Making Compositions

Additional embodiments of the present disclosure pertain to methods of making the compositions of the present disclosure. In some embodiments, the methods of the present disclosure include associating one or more biochars and one or more micro-organisms with a porous structure. As set forth in more detail herein, the methods of the present disclosure can have numerous embodiments.

The methods of the present disclosure may associate various biochars and micro-organisms with porous structures. Suitable biochars and micro-organisms were described supra and are incorporated herein by reference.

In some embodiments, the methods of the present disclosure also include a step of forming one or more biochars. In some embodiments, biochar formation occurs by pyrolysis of one or more biochar precursors. In some embodiments, the pyrolysis occurs at a temperature of at least about 500° C. In some embodiments, the biochar precursors include, without limitation, invasive weed giant reed, water hyacinth, water lettuce, wheat bran, pine, oak, corn stalks, vine waste, pine tree pruning waste, or combinations thereof.

In some embodiments, the methods of the present disclosure also include a step of forming a porous structure. In some embodiments, porous structure formation includes curing one or more precursors of the porous structure in the presence of one or more biochars. In some embodiments, the precursors of the porous structure include cement (e.g., Portland cement), which form concrete upon curing.

Various methods may be utilized to associate biochars and micro-organisms with porous structures. For instance, in some embodiments, the association occurs by a method that includes, without limitation, spraying, dispersion, impregnation, infiltration, or combinations thereof.

### Advantages and Applications

The methods and compositions of the present disclosure can have various advantages. In particular, unlike existing pervious structures, the compositions of the present disclosure can simultaneously perform physical infiltration, chemical adsorption, and biodegradation to enhance water quality in addition to runoff volume control. Moreover, the compositions of the present disclosure can be readily manufactured using commercially available materials (e.g., Portland type-I cement, biochar, aggregate, and/or microorganisms/bacteria) and conventional processes (e.g., pyrolysis, ball milling, molding, and/or curing). Additionally, the compositions of the present disclosure can decrease GHG/CO₂ emissions compared to producing a concrete block using conventional products (e.g., 100% Portland type-I cement). Furthermore, the configuration and geometry of the compositions of the present disclosure can be tailored as needed to address individual site-specific requirements for areas prone to runoff.

As such, the compositions and methods of the present disclosure can have numerous applications. For instance, in some embodiments, the compositions and methods of the present disclosure can be utilized to mitigate not only the erosional effects of groundwater/runoff but also the ability to reduce pollutants in the water via biosorption, biotransformation, and biodegradation, thereby minimizing contamination of aquifers, waterways, and the environment. Likewise, the methods and compositions of the present disclosure can be used to minimize erosion and pollutant contamination of runoff in a variety of applications, such as individual structures, community-based environments, and shoreline environments.

### ADDITIONAL EMBODIMENTS

Reference will now be made to more specific embodiments of the present disclosure and experimental results that provide support for such embodiments. However, Applicant notes that the disclosure herein is for illustrative purposes only and is not intended to limit the scope of the claimed subject matter in any way.

### Example 1. Biologically Active Pervious Structure (BAPS): A Sustainable Technology for Runoff Water Quality Improvement

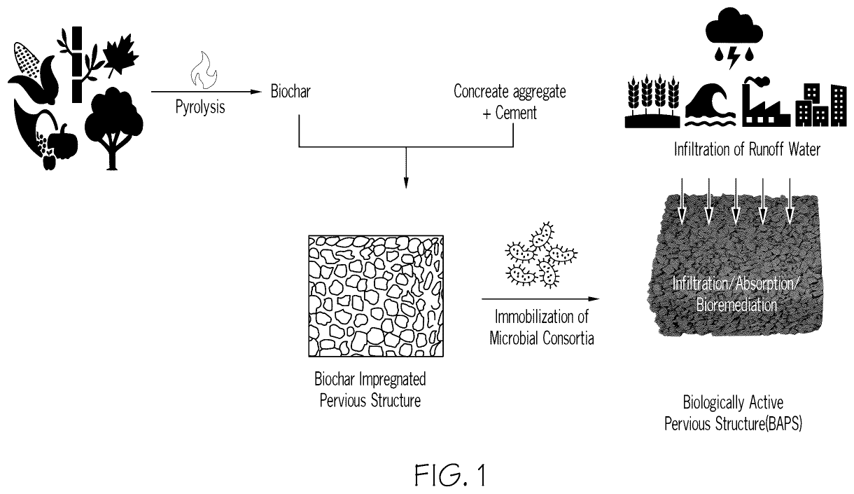

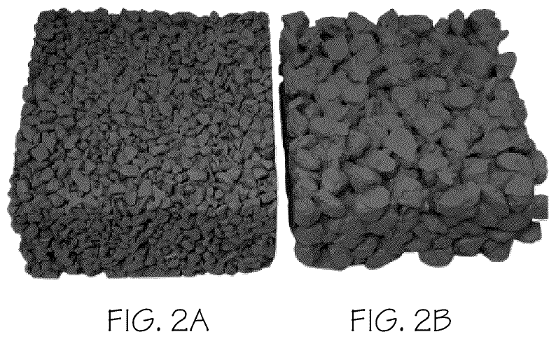

In this Example (FIGS. 1 and 2A-2B), biochar is produced by pyrolyzing invasive weed giant reed, water hyacinth, corn stalks, vine and pine tree pruning waste. Feedstocks are pyrolyzed at 500° C. for 2 h in a tube furnace with a heating rate of 10° C. in an oxygen-free environment, and the resulting biochars are ball milled and used.

The adsorption properties and capacity of each biochar are highly dependent on the type of feedstock used for pyrolysis. Therefore, Applicant has combined produced biochar at equal proportions and blended it with Portland type-I cement at the concentration of 1-4% w/w. The biochar-cement mixture is further added to aggregates (¼″ and ⅝″) and mixed in a mechanical mixture by adding water. Concrete blocks are cast in a mold (140 mm×60 mm×140 mm) and rested for 24 h by covering them with plastic sheets. After demolding, the biochar-impregnated pervious blocks are cured in a moisture chamber for 28 days.

For BAPS production, the screened and isolated microbes capable of biosorption, biotransformation, and biodegradation of a wide range of contaminants including fertilizers and organic pollutants (e.g., textile dyes, pesticides, petroleum hydrocarbons, volatile organic compounds) are immobilized on biochar-impregnated pervious structures. The seed culture of artificial bacterial consortium is produced by cultivating overnight at 30° C. in a minimal salt media using glucose (1%) as a carbon source.

Immobilization of bacterial consortia on pre-moist biochar-impregnated pervious blocks is performed by spraying the culture inoculum on the blocks and allowing the inoculum to infiltrate through the pervious blocks. These blocks are covered with plastic sheets to retain moisture and incubated at room temperature for 72 h.

Most of the conventional treatments applied to improve the runoff water quality are based on detention and retention basins, including settlement ponds, wetlands, swales, and bioretention basins. However, these treatments alone are ineffective, need huge land, and are inconvenient to apply in urban areas. Furthermore, classical runoff treatments further deteriorate the water quality and provide a breeding site for pests creating bad odors due to the decaying of organic matter.

Pervious concrete is used as an eco-friendly material to mitigate urban flooding and urban heat islands. However, contaminants in runoff may simply pass through pervious concrete matrix and still can pollute the soil environment and the receiving water bodies. Therefore, Applicant invented BAPS to infiltrate and treat the runoff water simultaneously.

BAPS technology consists of pervious structure impregnated with biochar derived from various waste biomass mentioned supra. These biochars have a high surface area and dominant functional groups (O—H, C—H, C—O—C, C═O, C═C) that helps to adsorb a wide range of pollutants, including ammonia, nitrate, 2,4-D, Picloram, textile dye, and heavy metals from water. Adsorption of contaminants on the biochar surface is mainly performed by complexation, electrostatic interaction, x-x interaction, pore-filling, ion exchange, and precipitation mechanism. Furthermore, biochar provided good compatibility with cement and asphalt and increased the strength of the pervious structure.

The biochar content above (4% w/w) increases the pollutant adsorption capacity. However, the porosity of the pervious blocks decreases, which can affect microbial growth. Incorporating biochar in the pervious structure slightly enhanced the water retention capacity that helped the interaction between contaminants and biochar surface. Biochar can also reduce greenhouse gas emissions by sequestration of stable carbon inherited from the feedstock, and incorporating biochar in concrete materials can also sequestrate carbon.

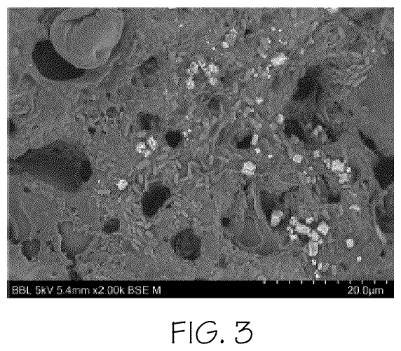

Microbes present in BAPS are responsible for biosorption, biotransformation, and bioremediation of contaminants absorbed into biochar. Microbes inoculated in the structure formed biofilm inside the void spaces of the biochar-impregnated pervious structure by producing exopolysaccharides (EPS) under nutrient-limiting conditions as well as abiotic stress inside the pervious structure (FIG. 3). These microbial EPS helped the microbial consortia to adhere and form biofilm inside the structure. EPS also acted as protective gear against toxic chemicals, heavy metals, and abiotic stress. The EPS also entrapped and immobilized the contaminants followed by degradation.

Although normal pervious concrete is reported for runoff water infiltration, these pervious structures are inefficient for adsorption and degradation of different contaminants during runoff water infiltration. Therefore, Applicant has developed specialized BAPS for improving the runoff water quality through physical infiltration, chemical adsorption, and biological degradation of the contaminants (FIG. 4).

BAPS is the technology where five types of biochar are blended with cement and aggregates to create pervious structures. This biochar-impregnated structure provides multiple benefits, such as enhancing the strength of the pervious structure, acting as a buffering reagent, providing a high surface area that provides space for microbes, and providing diverse functional groups for absorbing different types of contaminants. Furthermore, the artificial microbial consortia immobilized on the pervious structure facilitate degradation of the wide range of contaminants that adsorbed onto the biochar.

In summary, this Example details a conceptual BAPS to simultaneously treat runoff water and improve water quality by using microorganisms and bacteria and reduce their detrimental erosional effects by acting as a flow barrier. The developed BAPS consists of Portland type-I cement in a concentration of 1-4% w/w and biochar. Biochar is produced by pyrolyzing five different feedstocks in equal proportions (invasive weed giant reed, water hyacinth, corn stalks, vine waste, and pine tree pruning waste) at a temperature of 500° C. for 2 hours in a tube furnace at a heating rate of 10° C. in an O₂-free environment. After pyrolysis, the biochar is ball milled and blended with the Portland type-I cement. The biochar-cement mixture is then added to aggregates (e.g., ¼″ or ⅝″) and mixed using water to form concrete blocks, which are cast into a mold with the dimensions of 140 mm×60 mm×140 mm, which are allowed to set for 24 hours. After setting, the biochar-impregnated pervious blocks are cured in a moisture chamber for 28 days. A mixture of screened and isolated microbes capable of biosorption, biotransformation, and biodegradation of a wide range of runoff water contaminants (e.g., fertilizers, organic pollutants (textile dyes, pesticides, hydrocarbons, volatile organic compounds), etc.) are immobilized on the pre-moistened biochar-impregnated pervious structure by spraying the culture on the blocks, which infiltrates and absorbs through the blocks into its internal pore spaces. The culture forms a biofilm inside the blocks' pore spaces by producing exopolysaccharides (EPS). The sprayed biochar impregnated pervious blocks are then covered with plastic sheets to retain moisture and allowed to incubate at room temperature for 72 hours. The culture used to produce the artificial bacterial consortium used to treat the cement/biochar blocks is manufactured by cultivating overnight at 30° C. in a low-concentration salt media using glucose (1%) as a carbon source. Once produced, the BAPS are deployed as needed to provide runoff water volume control and absorb a range of contaminants from the surface water. SEM images of the BAPS internal pore spaces containing the colonized bacterial culture and pictures of the ¼″ and ⅝″ aggregates used in the cement-biochar mixture were presented. No tests of the developed BAPS were provided to gauge runoff water volume control and/or bioremediation/de-contamination capabilities in the disclosure.

### Example 2. Validation of Biologically Active Pervious Structures for Environmental Remediation

In this Example, Applicant conducted a series of experiments to further verify the proof-of-concept for the Biologically Active Pervious Structure (BAPS) described in Example 1. These experiments involved a comparative study of the impact of aggregate sizes (conventional limestone aggregate (CLA) #3 and #5), biochar addition (with and without), and bacteria immobilization (with and without) on water quality improvement (Table 1).

TABLE 1
Different pervious concrete blocks tested in the comparative study.

| | Aggregate | Biochar | Bacteria |
|---|---|---|---|
| System | Size | Addition | Immobilization |
| Pervious Block 1 | #5 | No | No |
| Pervious Block 2 | #3 | No | No |
| Pervious Block 3 | #5 | Yes | No |
| Pervious Block 4 | #3 | Yes | No |
| Pervious Block 5* | #5 | No | Yes |
| Pervious Block 6* | #3 | No | Yes |
| Pervious Block 7* | #5 | Yes | Yes |
| Pervious Block 8* | #3 | Yes | Yes |

*Biologically Active Pervious Structure (BAPS)

The interconnected voids within the concrete provide a physical filtration mechanism, capturing, adsorbing, and immobilizing contaminants. Specifically, the BAPS system was tested for its ability to remove bacterial contaminants (E. coli), organic contaminants (Chemical Oxygen Demand), and inorganic nutrients (nitrogen and phosphorus).

### Example 2.1. Production of the Pervious Blocks

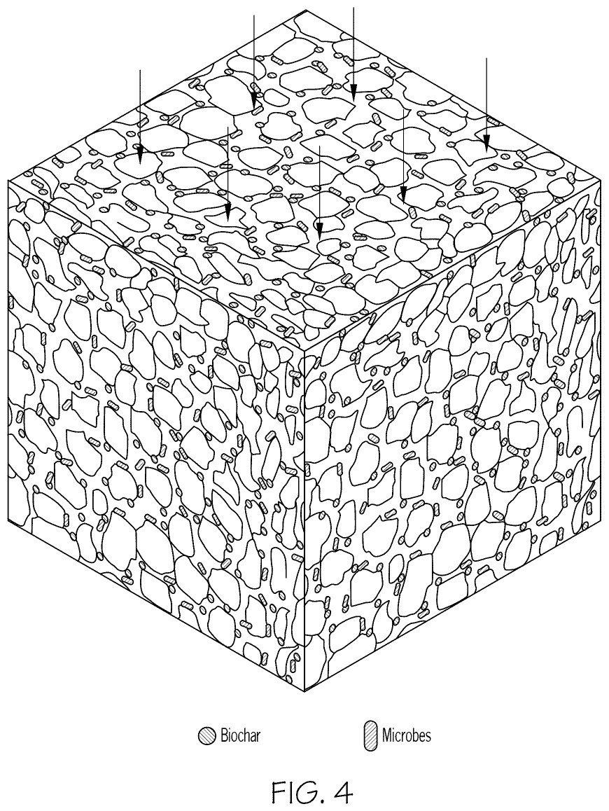

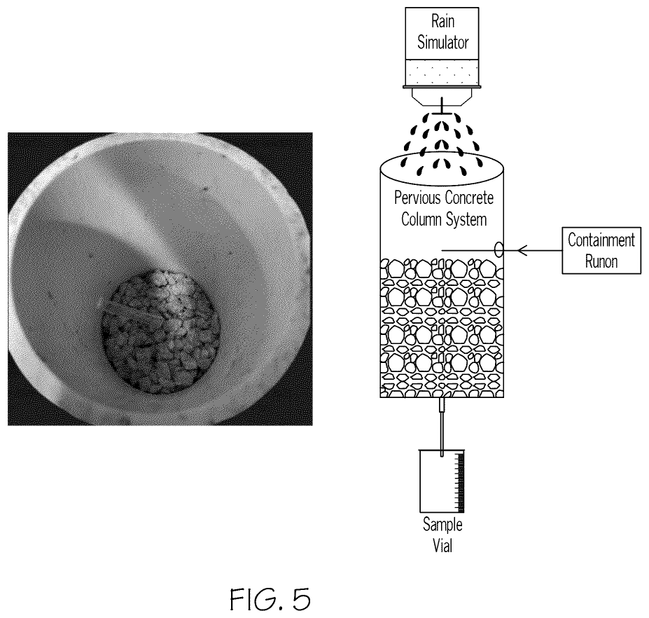

Using the concrete mix ratios shown in Table 2, the pervious concrete was cast in a cylindrical mold (FIG. 5) and then cured in a wet, calcium-rich environment. After 28 days of curing, the pervious concrete blocks were thoroughly washed with deionized (DI) water to remove any debris.

TABLE 2
Mix ratio of conventional limestone aggregate
(CLA)-based pervious concrete blocks.

| | | Type I/II | | | |
|---|---|---|---|---|---|
| | CLA | Cement | DI Water | Biochar | Water reducer |
| Weight (g) | 1700 | 425 | 121 | 14 | 0.425 |
| % | — | 25% of | 28.5% of | 5% of | 0.1% of |
| | | aggregate | cement | cement | cement |

The control CLA-based pervious concrete was made of the same mix design as the treatment, but without biochar addition.

### Example 2.2. Compressive Strength and Permeability of the Pervious Blocks

The pervious concrete blocks were cured for 28 days and tested for compressive strength and permeability. The compressive strength was quantified by ASTM C39, and the permeability was measured by a constant head method modified from ASTM D2434.

### Example 2.3. Bacteria Immobilization

Before the water quality performance tests began, immobilization of the bacterial consortia on pre-moist, biochar-impregnated pervious blocks was achieved by spraying the culture inoculum (Table 3) on the blocks and allowing the inoculum to infiltrate through the pervious blocks. The blocks were covered with plastic sheets to retain moisture and incubated at room temperature for 72 hours. Following immobilization, the produced BAPS was used for the remediation of aqueous bacterial, organic, and inorganic contaminants.

TABLE 3
Composition of culture inoculum used for immobilization
of bacteria in BAPS pervious concrete blocks.

| Component | Quantity per liter | |
|---|---|---|
| Peptone-based Nutrient Broth | 13 | g |
| Glucose | 1 | g |
| Sodium Acetate | 1 | g |
| BOD Nutrient Buffer (HACH) | 2.7 | ml |
| Polyseed (HACH) | 1 | capsule |

### Example 2.4. Water Quality Performance with BAPS

To investigate the removal performance of BAPS for bacterial, organic, and inorganic contaminants, the appropriate volume of contaminant solution for each system was prepared individually (Table 4).

TABLE 4
The initial concentration of contaminants.

| Contaminant | | Concentration |
|---|---|---|
| Organic | Glucose | 25 mg/L COD |
| Bacterial | E. coli (E. coli BW25113) | 2.5 × 10⁷ CFU/100 mL |
| Inorganic | Nitrogen and Phosphorus | 6 mg/L as NO₃_{^{−}}N, 1 mg/L as |
| | | PO₄³⁻—P |

The water quality performance experiments consisted of two phases for each system. The first phase was the contamination cycle where one pore volume of rainwater (350 mL of deionized (DI) water) and 50 mL of contaminant run on water was applied each cycle, whereas the second phase was the leaching cycle where a total of 400 mL DI water was applied. Each phase ran four cycles and each cycle lasted one hour.

The chemical oxygen demand (COD) was measured as a representation of the organic concentration (HACH Method 8000). E. coli were enumerated using the Colilert method. The concentration of nitrate and phosphate was analyzed by an ion chromatography (IC) (Dionex™ AS-DV, inuvion; Thermo Scientific™, USA) system equipped with an IonPac™ AS22 RFIC™ analytical column (250 mm×4 mm).

### Example 2.5. Compressive Strength and Permeability of Pervious Concrete Blocks

The compressive strength and the permeability of pervious concrete blocks made of #5 aggregate were 850 psi (or ˜6 MPa) and 10 mm/sec, respectively. In comparison, those pervious concrete blocks made of a larger aggregate (#3) had a lower compressive straight of 480 psi (or ˜3 MPa) but a greater permeability of 22 mm/sec than the counterpart.

### Example 2.6. Chemical Oxygen Demand

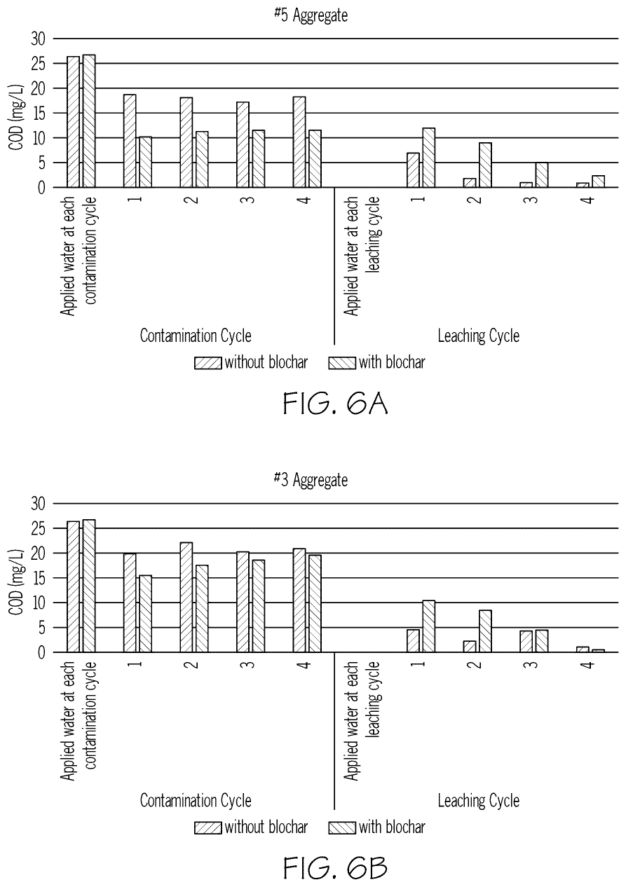

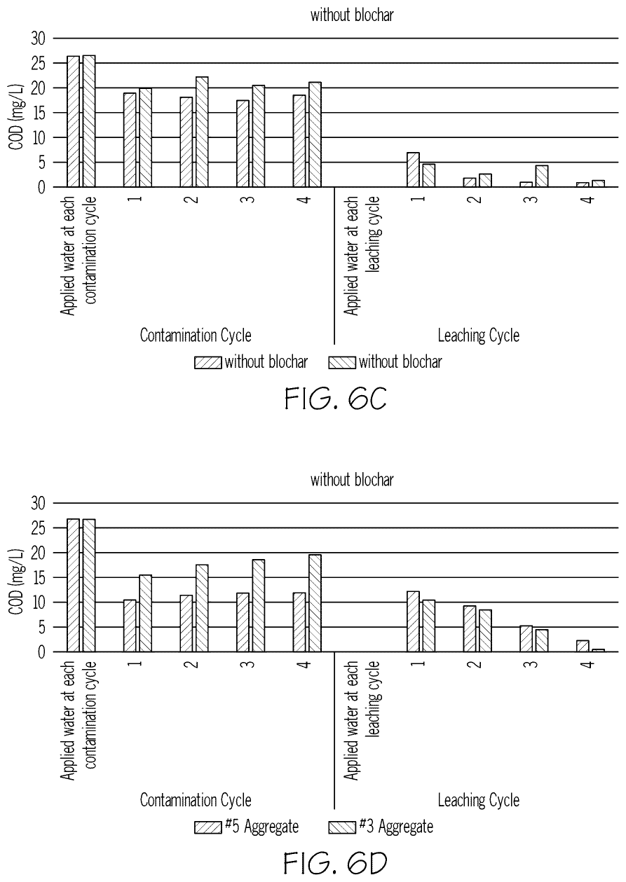

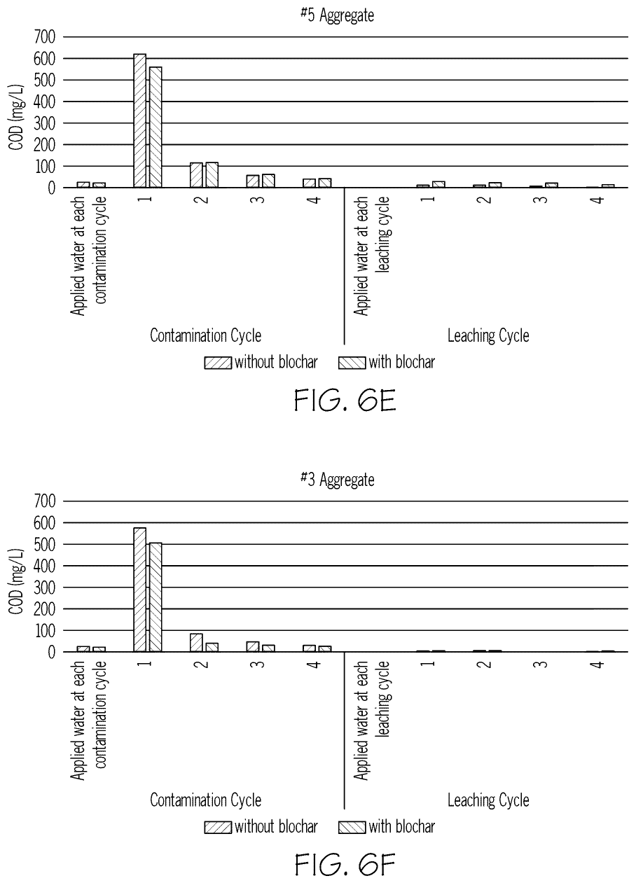

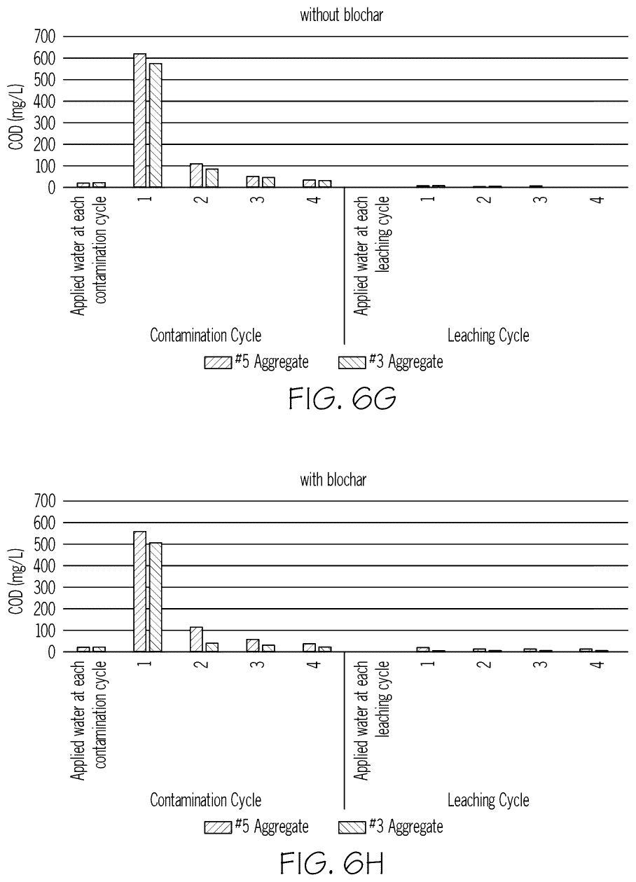

In general, pervious concrete blocks showed optimal COD reductions during the contamination cycles, with those made with biochar and a smaller aggregate (#5) showing better COD reductions (FIGS. 6A-6H). During the leaching cycles, COD gradually decreased and reached 0.9 mg/L to 2.2 mg/L COD for pervious concrete blocks made of #5 aggregate and 0.5 mg/L to 1.1 mg/L COD for those made of #3 aggregate.

Surprisingly, bacteria-immobilized pervious concrete blocks (i.e., BAPS) had significantly greater COD in the effluent of the first cycle (e.g., >500 mg/L COD). This could be attributed to the leaching of bacteria that were either not fully immobilized into the system, not able to immobilize due to high pH in the system, or grown in the pore water during the contact time at each cycle, which contributed to the COD analysis as organics. The COD concentration showed 2.1-25 mg/L COD during the leaching cycles, indirectly indicative of potential bacteria leaching.

### Example 2.6.1. Nitrate Content

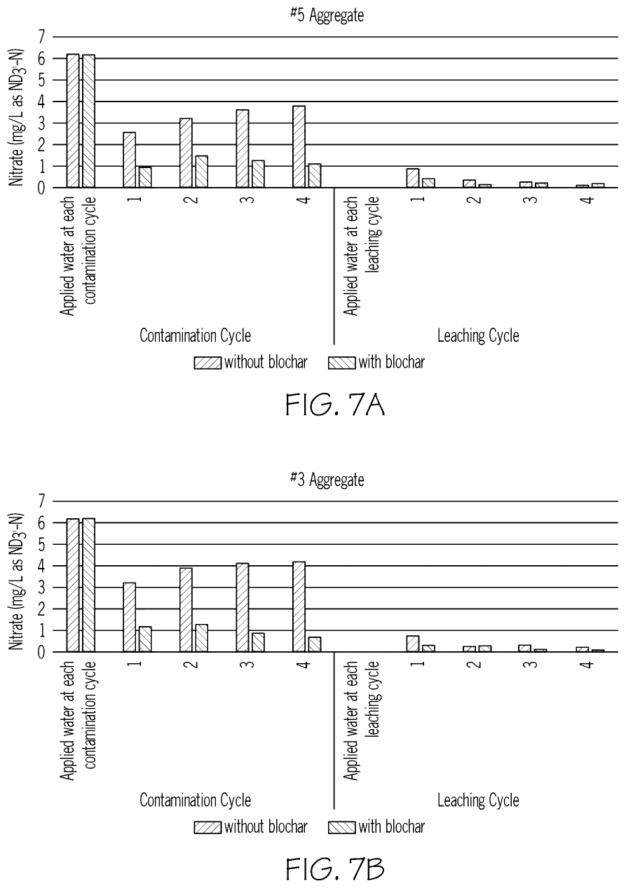

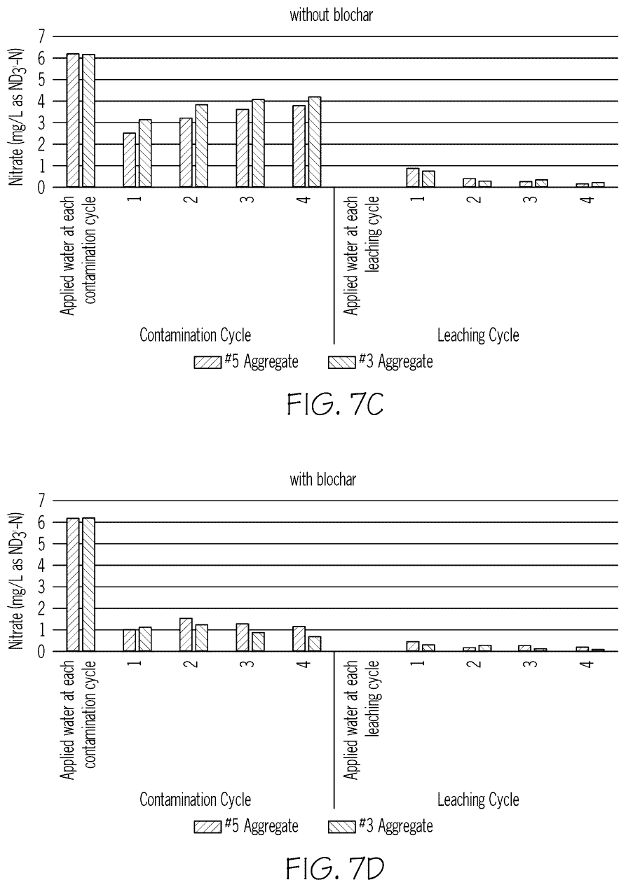

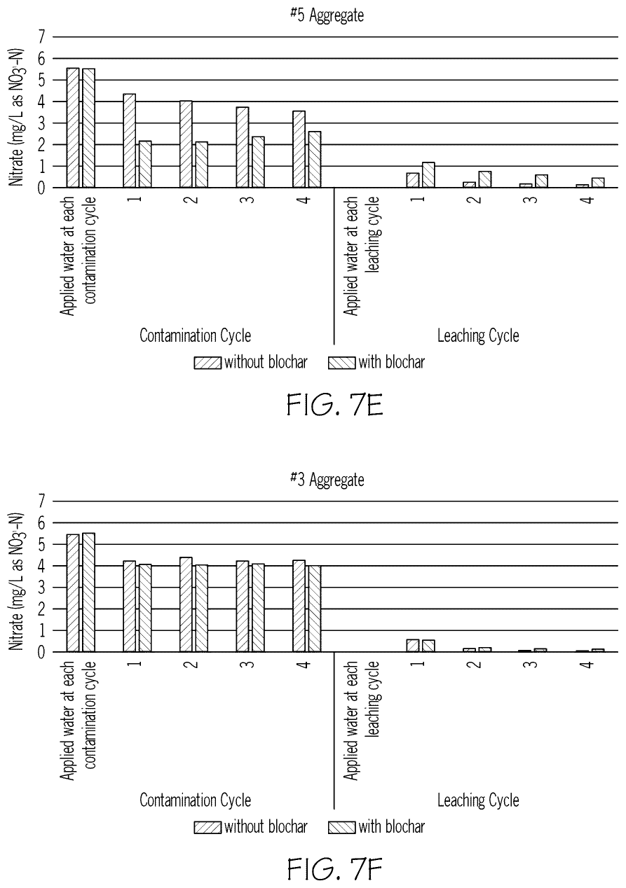

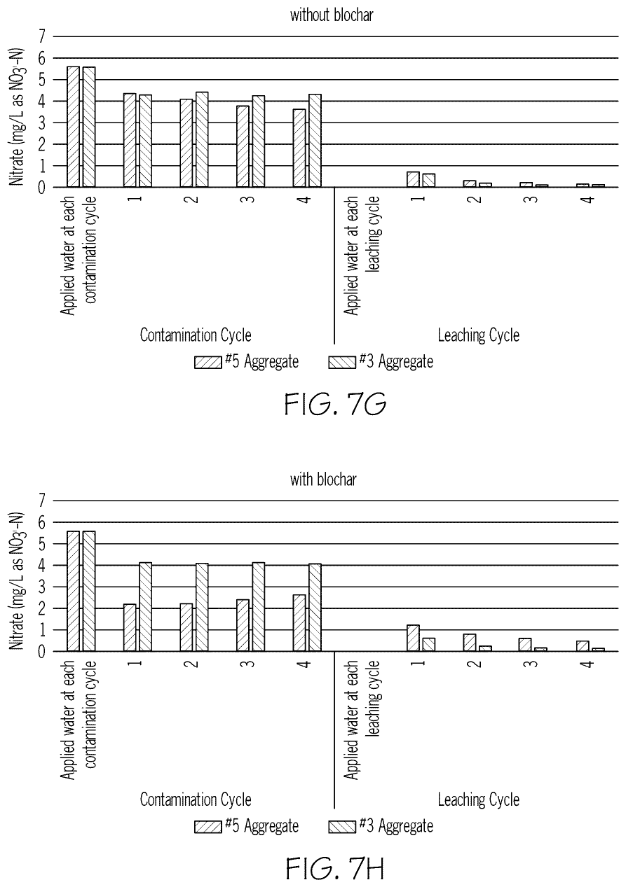

The nitrate concentration substantially reduced lower than 1.5 mg/L NO₃⁻—N from the initial 6.2 mg/L NO₃⁻—N for the pervious concrete blocks containing biochar (FIGS. 7A-7H). During the leaching cycles, the nitrate concentration was as low as 0.08 mg/L NO₃⁻—N to 0.19 mg/L NO₃⁻—N for the same blocks. When immobilized with bacteria, the same pervious concrete blocks had poorer nitrate reduction, especially for the blocks made with #3 aggregate, during the contamination cycles. However, the nitrate leaching from those blocks was not substantially higher than those counterparts without bacterial immobilization. The poorer nitrate reduction would have been due to the same reason for the poorer COD reduction for BAPS.

### Example 2.6.2. Phosphate Content

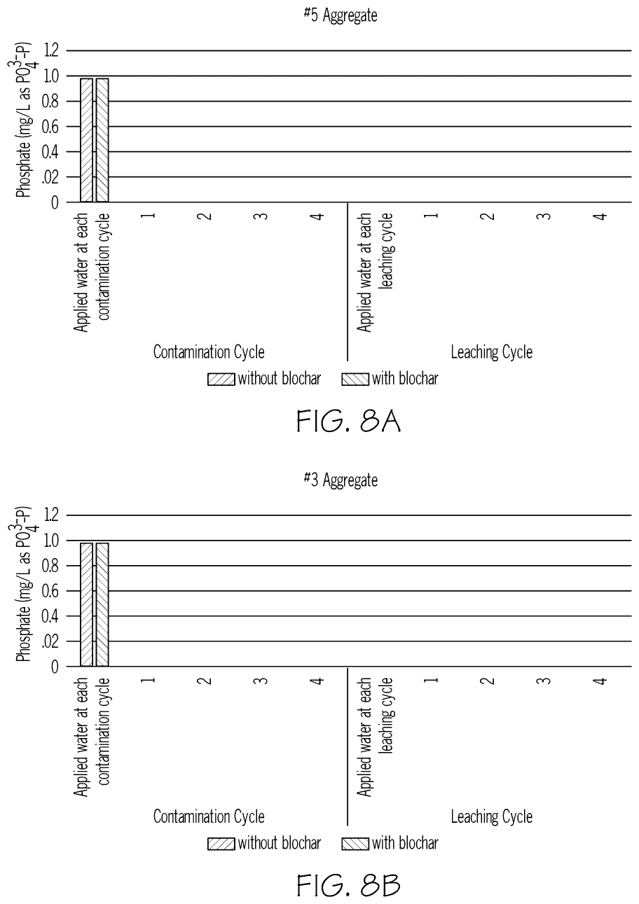

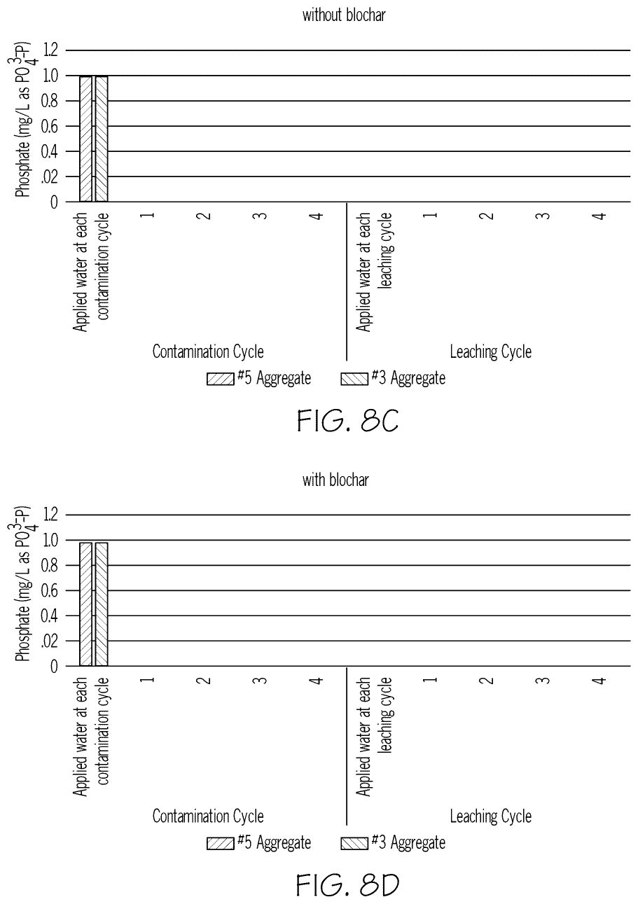

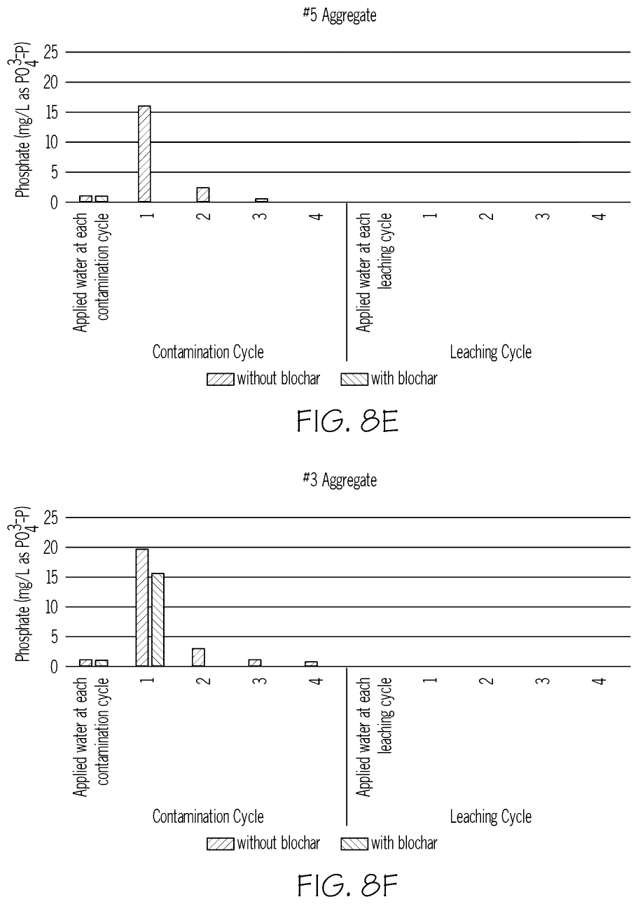

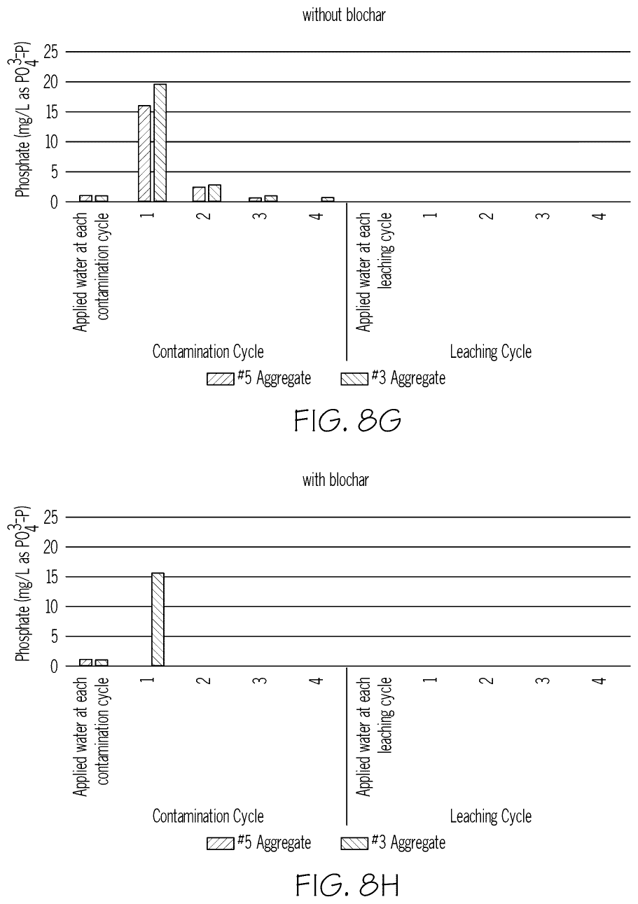

The pervious concrete blocks with and without bacterial immobilization demonstrated optimal reduction potential for phosphate (FIGS. 8A-8H). Those without bacterial immobilization showed 100% removal of phosphate. The BAPS, however, showed an initial spike of high phosphate concentrations at the first cycle of the contamination phase. However, the addition of biochar to the pervious concrete blocks made optimal removal of phosphate, resulting in 100% removal after the second cycle of the contamination phase. Regardless of the type of aggregate size and the presence/absence of biochar, no phosphate concentration was detected during the leaching phase. The abnormally high phosphate concentrations at the first cycle of the contaminant phase are also assumed to be related to the abnormally high concentrations of COD and nitrate due to the aforementioned bacteria leaching.

### Example 2.6.3. PH of the Blocks

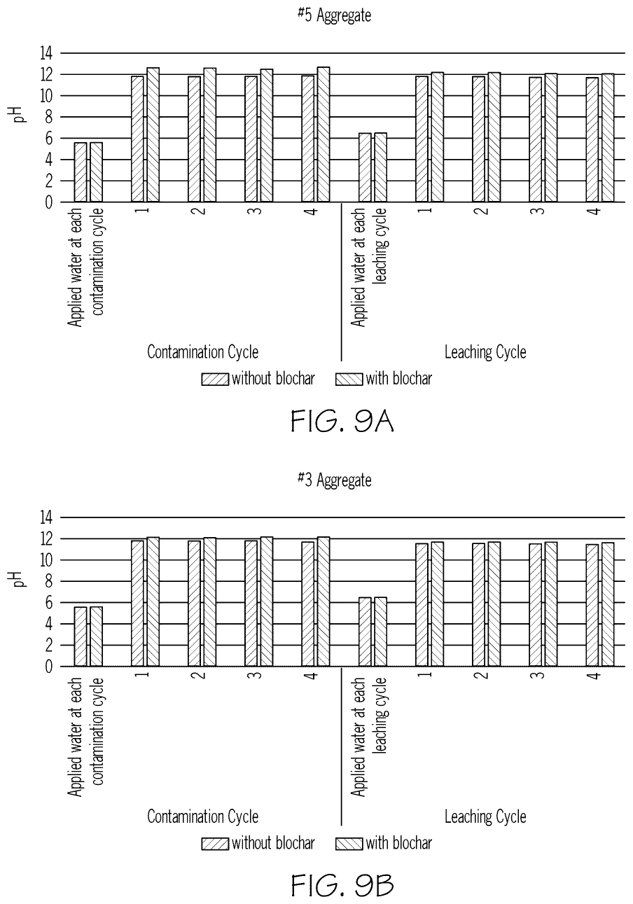

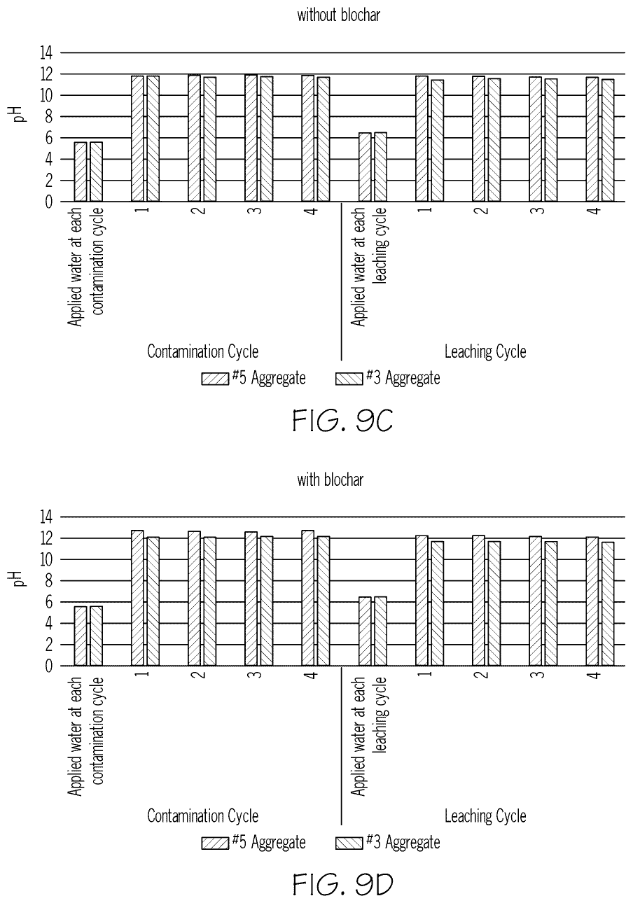

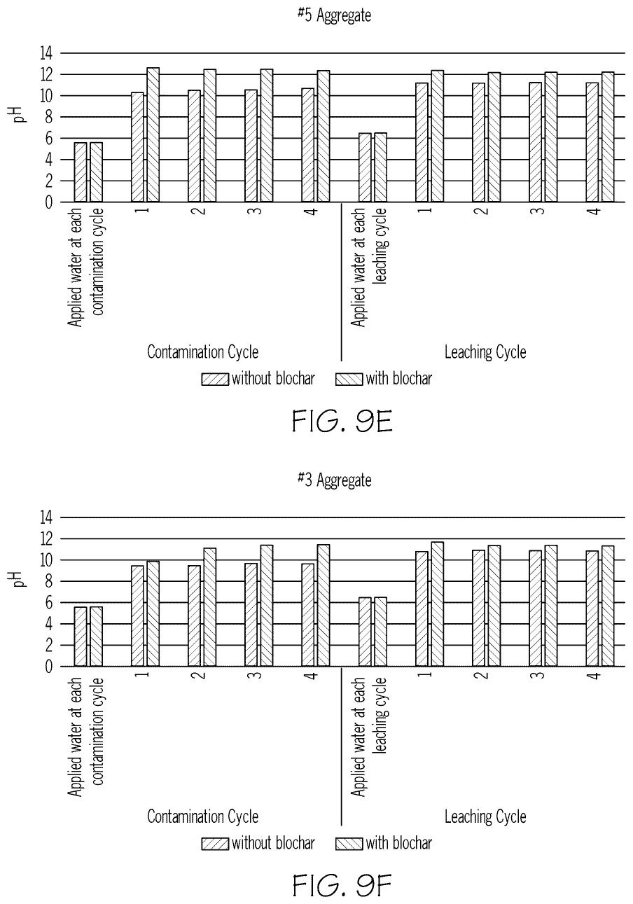

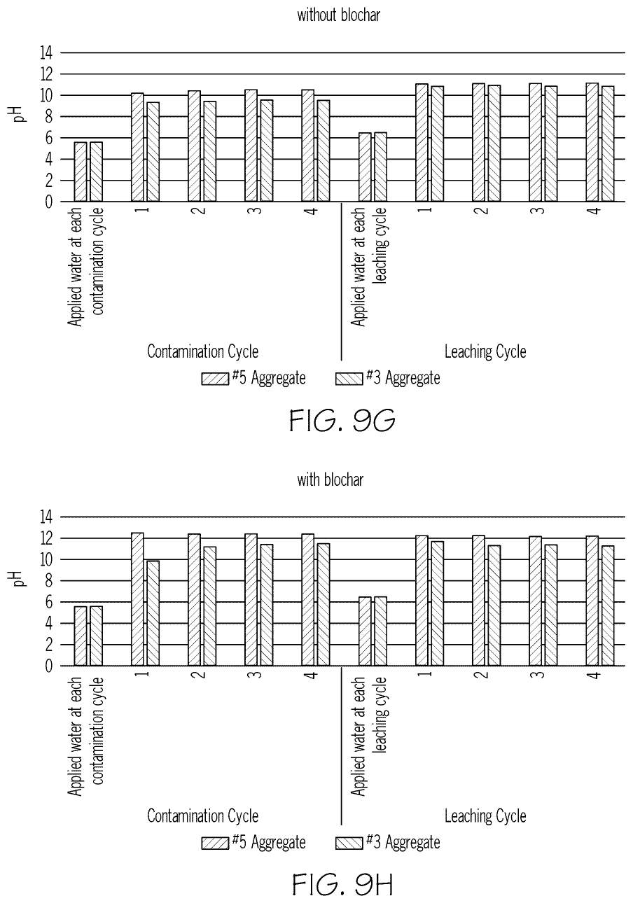

Due to the alkaline characteristics of the pervious concrete blocks, the values of pH ranged between 11.5 and 12.7, regardless of the biochar addition and the aggregate size (FIGS. 9A-9H). The BAPS showed slightly lower pH than those pervious blocks without bacterial immobilization. However, the pH values of the BAPS were still as high as 9.4 to 12.5. It is suspected that these high values of pH kept the added bacteria consortium from developing biofilm or bacterial growth in the system to some extent, resulting in higher concentrations of COD, nitrate, and phosphate eluted from the BAPS.

### Example 2.6.4. E. coli Content

The CLA-based pervious concrete blocks eliminated E. coli each cycle regardless of the addition of biochar and the size of aggregate, due probably to the alkaline characteristics of the system. As described previously, the pH values in the pore water of the pervious concrete blocks were generally more than 11, which would hinder biofilm development after bacterial inoculum.

### Example 2.7. Summary

The following conclusions can be drawn from the water quality performance experiments with BAPS for E. coli, COD, nitrate and phosphate. To begin with, BAPS performed well for E. coli removal, resulting in a 100% reduction with the pervious blocks, regardless of the aggregate size, biochar addition, and bacteria immobilization. Additionally, the pervious concrete blocks without bacteria immobilization but with biochar addition showed optimal reductions in the concentration of COD, nitrate, and phosphate. Moreover, indirectly judged by the high pH values (>11), the high concentrations of COD, nitrate, and phosphate eluted from the BAPS were potentially due to either incomplete bacteria immobilization into the system, the inability of bacteria to immobilize, or bacteria grown in the pore water during the contact time at each cycle.

### Example 3. Additional Testing of Biologically Active Pervious Structures for Environmental Remediation

In this Example, Applicant conducted a series of preliminary experiments to further verify the proof-of-concept for the biologically active pervious structures (BAPS) described in Examples 1-2. These experiments involved the comparative use of lightweight expanded clay aggregate (LECA) and conventional limestone aggregate (CLA) in pervious concrete matrices to create BAPS, designed to remove various contaminants from water. Additionally, the BAPS system was evaluated to demonstrate the significant impact of biochar inclusion on contaminant removal efficiency.

The interconnected voids within the concrete provide a physical filtration mechanism, capturing, adsorbing, and immobilizing contaminants. Specifically, the system was tested for its ability to remove bacterial contaminants (E. coli) and organic contaminants (2,4-Dichlorophenoxyacetic acid, 2,4-D).

### Example 3.1. BAPS Production

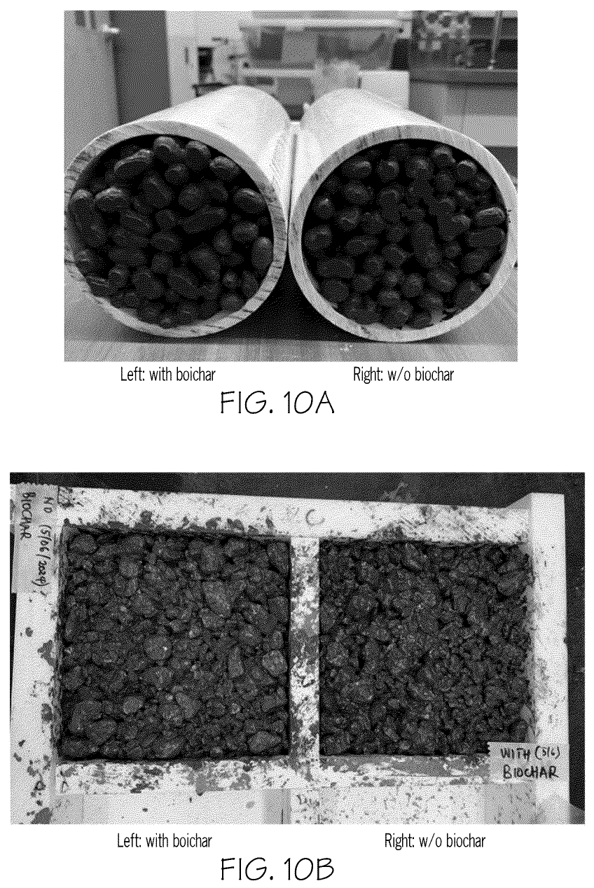

Using the concrete mix ratios shown in Table 5, the pervious concrete was cast in a cylindrical mold for LECA-based BAPS and a square mold for CLA-based BAPS (FIGS. 10A-10B), then cured in a wet, calcium-rich environment. After 14 days of curing, the pervious concrete blocks were thoroughly washed with deionized water to remove any debris. Once the desired pH (<10) was achieved, the blocks were included in the circulated batch reaction systems.

TABLE 5
Mix ratio of lightweight expanded clay aggregate (LECA)-
based pervious concrete (a) and conventional limestone
aggregate (CLA)-based pervious concrete (b).
(a) LECA-based pervious concrete

| | LECA | Cement | Water | Biochar | Water reducer |
|---|---|---|---|---|---|
| Weight (g) | 700 | 275 | 50 | 8.75 | 0.875 |
| % | — | 39.3% of | 18.2% of | 3.2% of | 0.3% of |
| | | aggregate | cement | cement | cement |

(b) CLA-based pervious concrete

| | CLA | Cement | Water | Biochar | Water reducer |
|---|---|---|---|---|---|
| Weight (g) | 1700 | 425 | 121 | 14 | 0.425 |
| % | — | 25% of | 28.5% of | 5% of | 0.1% of |
| | | aggregate | cement | cement | cement |

The control LECA-based pervious concrete was made of the same mix design as the treatment, but without biochar addition.
The control CLA-based pervious concrete was made of the same mix design as the treatment, but without biochar addition.

### Example 3.2. Bacteria Immobilization

Before the remediation tests began, immobilization of the bacterial consortia on pre-moist, biochar-impregnated pervious blocks was achieved by recirculating the culture inoculum (Table 6) through the blocks and allowing it to infiltrate for 24 hours. Pump speeds were set to 50 rpm using Masterflex L/S easy-load II peristaltic pumps, resulting in a recirculation flow rate of 500 mL/min. Following immobilization, the produced BAPS was used for the remediation of aqueous bacterial, organic, and inorganic contaminants.

TABLE 6
Composition of culture inoculum used for immobilization
of bacteria in BAPS pervious concrete.

| Component | Quantity per liter | |
|---|---|---|
| Peptone-based Nutrient Broth | 13 | g |
| Glucose | 1 | g |
| Sodium Acetate | 1 | g |
| BOD Nutrient Buffer (HACH) | 2.7 | ml |
| Polyseed (HACH) | 1 | capsule |

### Example 3.3. Remediation Experiment with BAPS

To investigate the removal of bacterial, organic, and inorganic contaminants, the appropriate volume of contaminant solution for each system was prepared individually by spiking each contaminant (Table 7) into the recirculating solution after bacterial immobilization.

TABLE 7
The initial concentration of contaminants.

| Contaminant | | Quantity per liter | |
|---|---|---|---|
| Organic | 2,4-D | 0.9 | mmol |
| Bacterial | E. coli | 1 | ml of inoculum |
| | (E. coli BW25113) | | |
| Inorganic (heavy metals) | Cadmium and Lead | 0.1 | mmol each |

Samples were taken at specified time intervals (0-24 hours) while the system was subject to continuous recirculation by a peristaltic pump. Pump speeds were set to 50 rpm using Masterflex L/S easy-load II peristaltic pumps, and this resulted in a recirculation flow rate of 500 mL/min. All tests were conducted at room temperature.

The concentration of 2,4-Dichlorophenoxyacetic acid was quantified after 4, 12, 20, and 24 hours of contact time using UV-Vis spectrophotometry at a wavelength of 291 nm. E. coli were enumerated after 24 hours of contact time using the Colilert method. Heavy metal concentrations were determined after 4, 12, 20, and 24 hours of contact time using inductively coupled plasma mass spectrometry (ICP-MS). General water quality parameters such as pH, conductivity, and hardness were evaluated using appropriate quantitative methods.

### Example 3.3.1. 2,4-D Removal

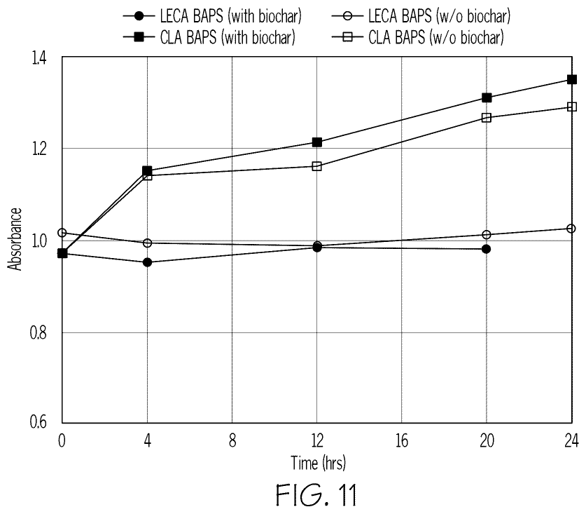

Based on the absorbance readings at 291 nm from the samples collected, the concentration of 2,4-D increased over time in the BAPS system, with the CLA-based BAPS showing a greater increase (FIG. 11). However, this increasing trend was potentially attributed to calcium leaching from the pervious concrete, as indicated by the measurements of pH (Table 8), conductivity (Table 9), and hardness (Table 10) in the solution.

TABLE 8
shows the trend of pH during BAPS remediation.

| | |
|---|---|
| LECA BAPS | CLA BAPS |

| Time | With | Without | With | Without |
|---|---|---|---|---|
| (hrs) | Biochar | Biochar | Biochar | Biochar |
| 0 | 6.17 | 6.28 | 6.71 | 6.43 |
| 4 | 6.87 | 7.02 | 11.02 | 10.21 |
| 12 | 7.53 | 7.71 | 11.24 | 11.08 |
| 20 | 8.24 | 8.16 | 11.15 | 11.06 |
| 24 | No Data | 8.26 | 11.33 | 11.17 |

TABLE 9
shows the trend of conductivity (in
mS/cm) during BAPS remediation.

| | |
|---|---|
| LECA BAPS | CLA BAPS |

| Time | With | Without | With | Without |
|---|---|---|---|---|
| (hrs) | Biochar | Biochar | Biochar | Biochar |
| 0 | 1.587 | 1.619 | 1.060 | 0.864 |
| 4 | 1.612 | 1.488 | 1.649 | 1.249 |
| 12 | 1.944 | 1.872 | 2.280 | 1.696 |
| 20 | 1.822 | 1.804 | 2.032 | 1.654 |
| 24 | No Data | 1.736 | 2.406 | 1.739 |

TABLE 10
shows the trend of hardness (in mg/L
as CaCO₃) during BAPS remediation.

| | |
|---|---|
| LECA BAPS | CLA BAPS |

| Time | With | Without | With | Without |
|---|---|---|---|---|
| (hrs) | Biochar | Biochar | Biochar | Biochar |
| 0 | 110 | 122 | 168 | 120 |
| 24 | No Data | 260 | 600 | 440 |

### Example 3.3.2. E. coli Removal

As shown in Table 11, both LECA- and CLA-based BAPS were effective in removing E. coli, with the CLA-based BAPS performing significantly better than the LECA-based BAPS. The addition of biochar in BAPS enhanced E. coli removal, as evidenced by the improved performance of the biochar-impregnated LECA-based BAPS. The CLA-based BAPS eliminated E. coli. However, the removal mechanism of E. coli in the CLA-based BAPS may be attributed to the alkaline characteristics of the system, as indicated by the pH values in Table 8.

TABLE 11
The trend of E. coli removal (in
MPN/100 mL) during BAPS remediation.

| | LECA BAPS | | CLA BAPS | |
|---|---|---|---|---|
| Time | With | Without | With | Without |
| (hrs) | Biochar | Biochar | Biochar | Biochar |
| 0 | >2.4 × 10⁷ | >2.4 × 10⁷ | >2.4 × 10⁷ | >2.4 × 10⁷ |
| 24 | 2.4 × 10⁵ | 8.1 × 10⁵ | 0 (at 10⁴ dilution) | 0 (at 10⁴ dilution) |

### Example 3.4. Discussion

The following conclusions can be drawn from the BAPS remediation tests for E. coli and 2,4-D. To begin with, BAPS performed well for E. coli removal, with CLA-based BAPS being particularly effective. Additionally, biochar impregnation in BAPS enhanced E. coli removal.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A composition comprising:
a porous structure,
wherein the porous structure is associated with one or more biochars and one or more micro-organisms.

2. The composition of claim 1, wherein the porous structure comprises concrete.

3. The composition of claim 1, wherein the one or more biochars comprise waste biomass-derived biochar.

4. The composition of claim 1, wherein the one or more micro-organisms comprise one or more bacteria colonized within the porous structure.

5. The composition of claim 1, wherein the one or more biochars and one or more micro-organisms are infiltrated into the porous structure.

6. The composition of claim 1, wherein the one or more biochars are operational to capture one or more contaminants from an environment, and wherein the one or more micro-organisms are operational to degrade the one or more captured contaminants.

7. A method of capturing one or more contaminants from an environment, said method comprising:
associating the environment with a composition,
wherein the composition comprises a porous structure,
wherein the porous structure is associated with one or more biochars and one or more micro-organisms, and
wherein the composition captures the one or more contaminants from the environment.

8. The method of claim 7, wherein the associating comprises flowing the environment through the composition.

9. The method of claim 7, wherein the environment is selected from the group consisting of a gaseous environment, a liquid environment, or combinations thereof.

10. The method of claim 7, wherein the environment comprises a water source.

11. The method of claim 7, wherein the one or more contaminants are selected from the group consisting of inorganic contaminants, organic contaminants, microorganisms, fertilizers, pesticides, dyes, salts, toxins, or combinations thereof.

12. The method of claim 7, wherein the one or more contaminants comprise one or more inorganic contaminants selected from the group consisting of heavy metals, cadmium, lead, nitrates, phosphates, ammonia, or combinations thereof.

13. The method of claim 7, wherein the one or more contaminants comprise one or organic contaminants selected from the group consisting of organic pollutants, volatile organic compounds, hydrocarbons, polycyclic aromatic hydrocarbons, 2,4-dichlorophenoxyacetic acid, or combinations thereof.

14. The method of claim 7, wherein the one or more contaminants comprise one or more microorganisms selected from the group consisting of pathogens, bacteria, fungi, viruses, or combinations thereof.

15. The method of claim 7, wherein the one or more biochars capture one or more contaminants from the environment, and wherein the one or more micro-organisms degrade the one or more captured contaminants.

16. A method of making a composition, said method comprising:
associating one or more biochars and one or more micro-organisms with a porous structure.

17. The method of claim 16, further comprising a step of forming one or more biochars.

18. The method of claim 17, wherein the forming comprises pyrolysis of one or more biochar precursors, wherein the pyrolysis occurs at a temperature of at least about 500° C., and wherein the one or more precursors are selected from the group consisting of invasive weed giant reed, water hyacinth, water lettuce, wheat bran, pine, oak, corn stalks, vine waste, pine tree pruning waste, or combinations thereof.

19. The method of claim 16, further comprising a step of forming the porous structure, wherein the formation comprises curing one or more precursors of the porous structure in the presence of one or more biochars.

20. The method of claim 19, wherein the porous structure comprises concrete, and wherein one or more precursors of the porous structure comprises cement.
